(19) United States
(12) Patent Application Publication
(10) Pub. No.: US 2026/0368390 A1
(43) Pub. Date: Nov. 19, 2026

(54) METHOD FOR GENERATING BITMAP DATA FOR LAYERWISE MANUFACTURE OF 3D OBJECTS

(71) Applicant: Stratasys Powder Production Ltd., Nottingham (GB)

(72) Inventor: Gianluca DORINI, Nottingham (GB)

(21) Appl. No.: 19/143,329

(22) PCT Filed: Nov. 3, 2023
(86) PCT No.: PCT/GB2023/052880

§ 371 Date: Jun. 25, 2025

(30) Foreign Application Priority Data
Dec. 29, 2022 (GB) 2219819.6

(51) Int. Cl. G06F 30/20; B29C 64/393; B33Y 50/02; G06F 113/10; G06F 119/18

(52) U.S. Cl. CPC G06F 30/20; B29C 64/393; B33Y 50/02; G06F 2113/10; G06F 2119/18

(57) ABSTRACT

A method for generating formation data for a plurality of object model repeat units for the layerwise formation of object repeat units based on the formation data. The method includes the steps of: providing a plurality of virtual build volume slices stacked in the layering direction of a corresponding object formation process and based on a thickness of layers of the object repeat units to be formed; slicing the object model repeat unit to form a repeat unit slice stack of repeat unit slices; defining a position and orientation for each of a plurality of the repeat unit slice stacks over a number of base slices; and generating a base slice stack by placing each of the repeat unit slice stacks within the base slice stack. An object formed according to the method. A processor configured to carry out the method are also provided.

### FIELD OF THE INVENTION

The present disclosure relates to a method for generating formation data for the layerwise formation of three-dimensional (3D) objects by a 3D manufacturing apparatus. The method may be particularly beneficial for manufacturing technologies where the layerwise cross sections of an object are defined in the form of bitmaps.

### BACKGROUND

As additive manufacturing technologies continue to evolve, ever more challenging applications require new solutions. Accuracy and yield are important considerations for industrial applicability of techniques. For example, manufacturing a variety of objects accurately throughout the build volume is a known problem. In powder bed fusion technologies, in which objects are built layer by layer and which apply thermal energy to cause consolidation of the build material over defined cross sections of the objects, compensation for warp and shrinkage remain a challenge as accuracy requirements and build volumes increase. Warp and shrinkage become more pronounced where objects extend over a significant portion of the build volume and/or have a large thermal mass, while smaller objects may not be affected to the same detrimental degree. However, industrial manufacture of multitudes of small objects has its own challenges. To make manufacture of small objects economically viable, they need to be densely packed to maximise the yield from the available build volume. This concept may be further extended to a fabric comprised of thousands or tens of thousands of small objects in the form of repeating links conventionally described in STL file format. Conversion of resulting large STL files to bitmap format as is required by high throughput technologies, such as powder bed ones employing printheads like binder jet or “print and fuse”, leads to excessive computational processing time, and improvements in generating such formation data are needed.

### SUMMARY

The following disclosure describes, in an aspect, a method for generating bitmap data for the layer by layer manufacture of 3D objects according to claim 1. Particular embodiments of the invention are set out in the appended dependent claims. An object formed by use of the bitmap data and a processor for generating the bitmap data is also disclosed.

### BRIEF DESCRIPTION OF THE DRAWINGS

Reference is now directed to the drawings, in which:

FIG. 1 is a flow chart for a method for generating bitmap data according to the invention;

FIGS. 2A to 2C schematically illustrate details of an object comprised of repeat units;

FIG. 3 schematically illustrates in plan view a sequence of bitmap data for the repeat unit of FIG. 2B;

FIG. 4 schematically illustrates in plan view a slice of the virtual build volume to which bitmap data is copied from repeat unit slice stacks according to the method of the invention;

FIGS. 5A and 5B are schematic illustrations of the virtual build volume over which the repeat unit of FIG. 2C is arranged according to two variants of the invention;

FIGS. 6A to 6C schematically illustrate details of an object comprised of repeat units interlinking along two dimensions;

FIG. 7 schematically illustrates in plan view a base slice stack to which repeat unit slice stacks are to be copied to form the slice data for a bale of fabric;

FIGS. 8A and 8B schematically illustrate, respectively, a plan view and side view of a variant repeat unit used to define a folded object;

FIG. 9 schematically illustrates a cross section of a repeat unit slice stack based on the repeat unit of FIGS. 8A and 8B;

FIG. 10 schematically illustrates a cross section through the virtual build volume to which multiple repeat unit slice stacks of FIG. 9 have been copied;

FIG. 11 schematically illustrates a cross section through three base slice stacks to which repeat unit slice stacks have been copied in staggered formation;

FIG. 12 schematically illustrates a cross section through the virtual build volume to which multiple repeat unit slice stacks of FIG. 10 have been copied around voxels of larger objects;

FIG. 13A is a 3D representation of a variant of an object model repeat unit;

FIG. 13B is a 3D representation of the object model repeat unit of FIG. 13A interlinked with an adjacent object model repeat unit illustrating overlap;

FIG. 14 is a flow chart of a variant of the method of FIG. 1; and

FIG. 15 is a flow chart of a further variant of the method of FIG. 1.

In the drawings, like elements are indicated by like reference numerals throughout.

### DETAILED DESCRIPTION

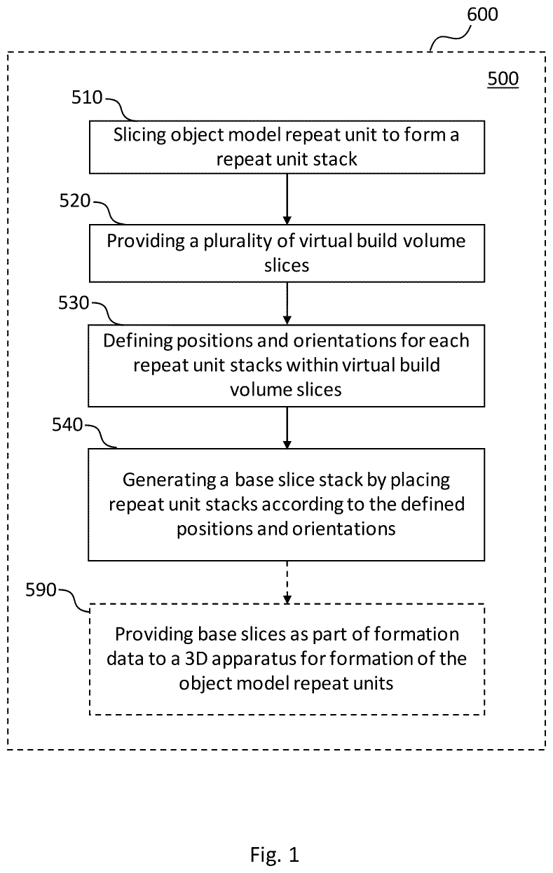

A method according to the invention for generating bitmap data to define the sequential object cross sections of objects for layerwise manufacture using a 3D manufacturing apparatus will now described with reference to FIGS. 1 to 15.

Conventionally, formation data for additive manufacturing is prepared entirely from STL file format of the object models placed in the virtual build volume, before the entire virtual build volume is sliced to form bitmap data. STL files define the closed surface contours of a 3D object in terms of a multitude of identically shaped triangular planes, each having position coordinates and orientation vectors. They are thus relatively larger files compared to bitmap files, which are a binary voxel representation of the object. The inventor has developed a method for generating the bitmap data for a large number of repeating objects that avoids the processing of large STL files in the conventional manner.

Turning first to FIG. 1, the method 500 of generating formation data for a plurality of object model repeat units for the layerwise formation of object repeat units based on the formation data according to the invention is illustrated by way of a flow chart, and comprises:
at block 510, slicing the object model repeat unit to form a repeat unit slice stack of repeat unit slices, the slices stacked in the layering direction of a corresponding object formation process. The object model repeat unit within the unit slices may have a defined origin and orientation with respect to the layering direction, and which may be chosen or defined based on a required direction of repeat. It may therefore be selected to be at a specified orientation with respect to an axis extending through its defined origin for example, or through a point of rotation with respect to an adjacent repeat unit, as will be described below.
at block 520, a plurality of virtual build volume slices are provided, the virtual build volume slices being of same thickness in a layering direction as the repeat unit slices. The order of these first two blocks is not important. The virtual build volume slices may be provided according to the layer thickness the apparatus for formation of the objects may be arranged to achieve, and may be used to define the separation of the slice planes applied at block 510 in respect of slicing the object model repeat unit.
at block 530, a position and orientation for each of a plurality of the repeat unit slice stacks is defined within one or more base slices of the virtual build volume.
at block 540, the virtual build volume slices are filled by placing each of the plurality of the repeat unit slice stacks according to its defined position and orientation to form a base slice stack. The base slice stack is comprised within and may be all of, or be a sub-volume of, the virtual build volume. Each repeat unit slice stack may be placed with its defined origin according to a position coordinate within the base slices and oriented by rotating about one or more axes, for example extending through the origin position.

At block 590, the virtual build volume slices comprising the base slice stack may optionally be provided to the apparatus to form the object repeat units, or they may be stored in a memory to be combined with further, similarly prepared, and optionally different, base stack slices.

Regarding the first two steps of at block 510 and 520, “generating slices” means generating a layerwise bitmap representation of the object model repeat unit, or, as applicable, of the virtual build volume, which are initially defined in a different file format such as STL or ASCII format. Where the virtual build volume comprises other objects in STL format, slicing also converts these objects into layers of slices in bitmap format. The virtual build volume may alternatively be empty and not initially described in STL format, but simply provided in the form of a plurality of sequential empty bitmaps (slices).

Bitmap or raster data as used herein is a representation of each slice in the form of pixels or 3D voxels defining each object as a stack of horizontal cross-sections for each layer. Technologies using such type of data may form the object cross section of each layer by consolidating the build material within the cross sectional areas at the same time, or by scanning across it along one direction (left to right, front to back). Consolidation may for example be achieved by applying melting energy using multiple heaters or radiation emitters, or using printheads with multiple nozzles in combination with one or more radiation emitters (e.g. “print and fuse” or high speed sintering technologies), and for which the bitmap data forms the input to the multiple heaters or printheads.

Alternative technologies that compose the cross sections by tracing the cross sectional contours and filling their interior, such as by using orientable lasers or extruders, require data in the form of vector input data that further defines routing of the consolidation path. Nonetheless the method according to this invention may also be beneficial for these technologies, provided that the raster data can be translated into vector data.

Thus by applying the method according to the invention described herein, bitmap data may be generated by converting only the STL file of the object to be repeated, or an object repeat unit, into a unit stack of bitmap slices, and copying and pasting (repeating) the unit stack of bitmap slices to defined locations and with defined orientations into a stack of bitmap slices of the virtual build volume. In this way, the bitmap data for e.g. a fabric may be substantially generated from bitmap format, and not from STL format. Since there are typically many thousands of links, or repeat units, describing a fabric, significant savings may be made in processing time by reducing or minimising the size of STL data to be converted.

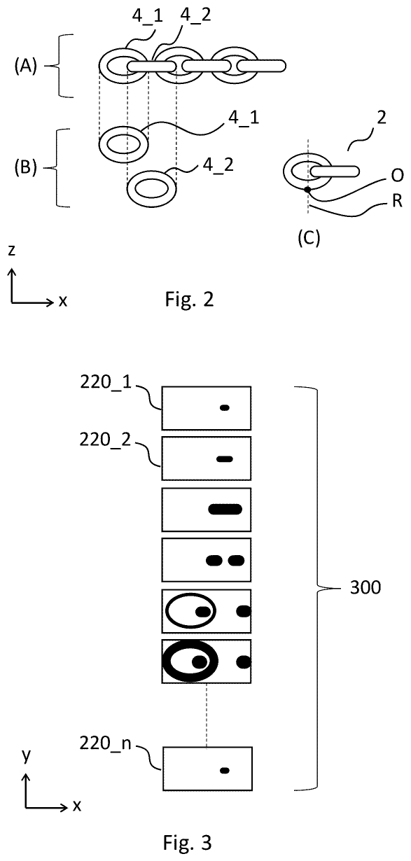

### Simple Chains, FIGS. 2-5B: Interlinking in One Plane

FIGS. 2A-2C illustrates the method further with the example of a simple chain link as object model repeat unit to form an object in the form of a chain from multiple interlinked object model repeat units.

FIG. 2A shows a schematic side view of a link 4 assembled to form a short chain section. The chain may be arranged lying flat, to be formed within the plane of a stack of slices. A first link 4_1 is orientated upright on its edge in a vertical plane along z-x, and a second, otherwise identical, link 2_2 is aligned flat, parallel to the horizontal plane along x-y. FIG. 2B is a top view of the first and second links 4_1 and 4_2, which are identical in this example save for their orientation. An example of a repeating link comprising both first and second links may be defined as illustrated in FIG. 2C. An origin O and axis of rotation R is further shown, although these may be defined differently-for example the origin may define one of the extremes along the x-direction of the outline of the repeat unit of the object. Alternatively, the origin and axes of rotation may be defined with respect to an outline of the sliced repeat unit, i.e. the repeat unit slice stack 300.

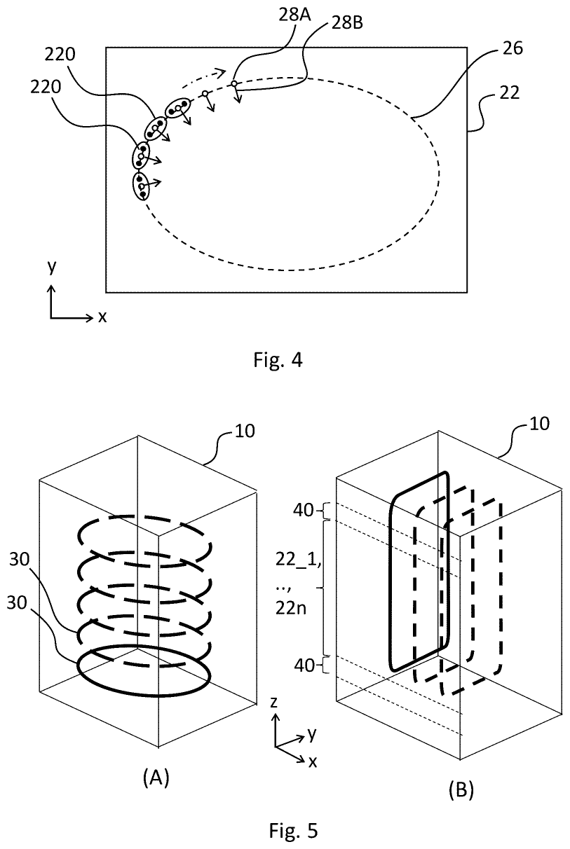

From the STL format of the repeat unit of the object 2 of the chain, a stack of repeat unit slices may be generated. This is illustrated in FIG. 3, schematically showing a sequence of repeat unit slices 220_1, 220_2, . . . 220_n in plan view (x-y plane) created from the bottom up along the vertical direction (the layering direction). Within each repeat unit slice, or repeat unit bitmap 220, the black areas represent voxels defining the cross section of the repeat unit of the chain through the repeat unit slice stack. The sequence of repeat unit slices 220n forms the repeat unit slice stack 300. Next, within a base slice stack of virtual build volume slices, which may be empty, the position and orientation for each repeat unit is defined, ensuring that adjacent repeat unit slice stacks 300 interlink with one another. For a simple illustration, FIG. 4 shows a slice 22 of the base slice stack in plan view, and over which a plurality of position coordinates 28A and orientation vectors 28B are defined with respect to the defined origin O and axis of rotation R shown in FIG. 2C, such that the plurality of repeat unit slice stacks 220 are part of interlinking repeat unit slice stacks 300. The interlinking repeat unit slice stacks 300 are thus copied and pasted into the base slice stack such that they may be provided to the 3D apparatus to form a continuous chain lying flat within the base slice stack.

The number of slices in the repeat unit slice stack 300 may be the same as that in the base stack of slices, however this is not necessary. The base stack of slices 30 may next be repeated along the vertical direction for the manufacture of a plurality of chains, as illustrated in FIG. 5A, which schematically illustrates a virtual build volume 10 with slices that comprise plural base slice stacks 30.

Interlinking may also be generated along the vertical direction using the method according to the invention depending on how the object model repeat unit is defined.

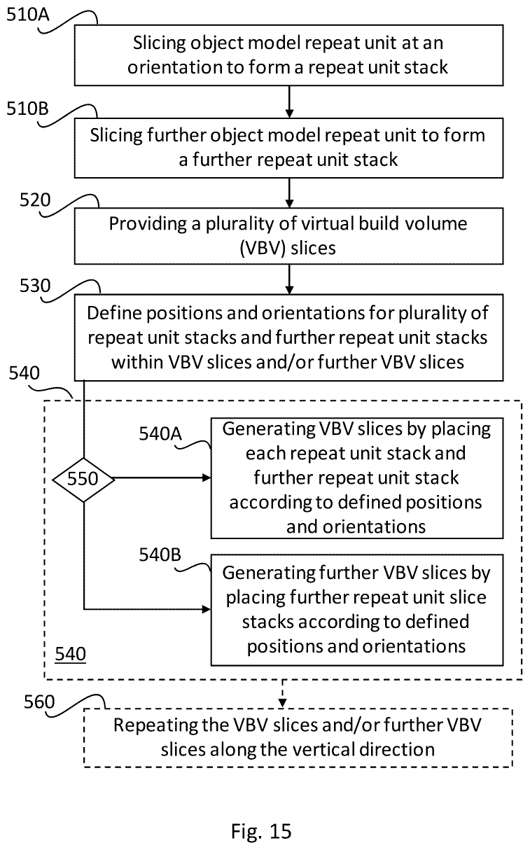

FIG. 5B illustrates a variant in which the chains are formed as vertically extending loops, parallel to the z-y plane, within the virtual build volume 10, and optionally repeated at different locations along x. This may allow forming more complex shapes from repeating repeat units, and is here illustrated in a simplified form, using the repeat unit 2 of the object. It can be seen that for the sections of the chain lying within the x-y plane, a similar approach to the one in FIG. 4 may be applied. For sections of the chain linking along the vertical direction, which in FIG. 5B is along slices 22_1 to 22_n, the unit base slice stack may be defined differently, over a second base slice unit stack created from the object model repeat unit oriented in a different orientation with respect to the layering direction and using the same principle as previously described. This second base unit slice stack may comprise more layers than the first base unit slice stack defining the repeat units within the two top and bottom portions 40 of the virtual build volume in which the repeat units are purely oriented within the horizontal direction. Furthermore, within the two top and bottom portions 40, a series of transition unit base slice stacks may be defined that link the first repeat unit slice stacks with the second unit base cell stacks over a number of transition slices. For example, over the transition base slices of the virtual build volume, the orientation vectors may have a component along the vertical direction so as to suitably rotate the base repeat unit stack to follow the path within the virtual build volume 10. For these orientations along the path 26 having an orientation vector 28B out of the plane of the slice 22, a library of repeat unit stacks 300n may be generated, each defining one of a unique orientation and requiring a certain number of repeat unit slices. As the chain is completed along the path 26, each base repeat unit may be selected based on the path 26 to be followed within the virtual build volume 10. Alternatively, the transition slices may be generated conventionally from STL format and combined with the base slice stacks generated according to the invention. FIG. 15 describes a further alternative.

As before, the first and second and transition base repeat unit stacks may be translated along the lateral direction, here shown in x, to form a number of chains following a path 26 identical to the adjacent path and offset laterally.

An additional step of the method according to the invention may therefore comprise repeating the base slice stack one or more times along the vertical direction so as to generate bitmap data for a vertically extending object of identical repeat sections such as shown in FIG. 5A by repeating the base slice stack 30, and in FIG. 5B where the slices of the virtual build volume 22 may also be described in terms of base slice stacks 30 for all objects to be formed between the two sets of non repeating slices or transition slices 40.

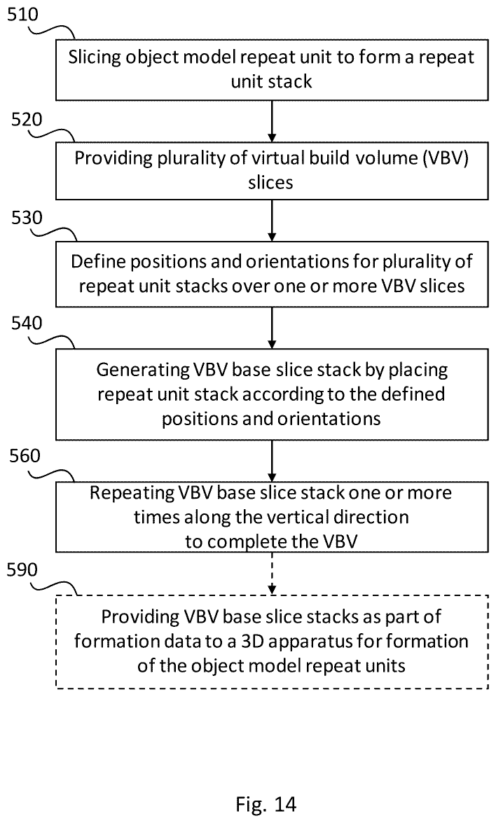

FIG. 14 is a flow chart according to a variant of the method 500 of FIG. 1. A further block 560 comprises repeating the base slice stack one or more times along the vertical direction to further fill the virtual build volume slices 22 with voxel data. In this way, further time savings may be made by copying the base slice stack 30 one or more times to form a stack of base slice stacks 30. The virtual build volume slices 22 comprising the base slice stacks 30 may next be provided at block 590 to the apparatus to form the one or more objects defined by the repeat unit slice stacks within the base slice stacks. Alternatively, for an industrial process for example, the generated base slice stacks may be stored in a memory such as a library of base slice stacks or completed slices of a virtual build volume for later use.

The orientation of the plurality of the repeat unit slice stacks may be defined by a rotation about the vertical axis though the position coordinate of each repeat unit slice stack. In variants, the object model repeat unit 2 may be defined such that it interlinks with a laterally adjacent repeating element model within the base slice stack. A step preceding block 510 may further comprise defining the object model repeat unit 2 to include part of the laterally adjacent object model repeat unit 2, such that the step at block 530 comprises defining the plurality of locations and orientations for the object model repeat unit 2 such that each adjacent object model repeat units 2 form an interlinked portion of the object within the base slice stack.

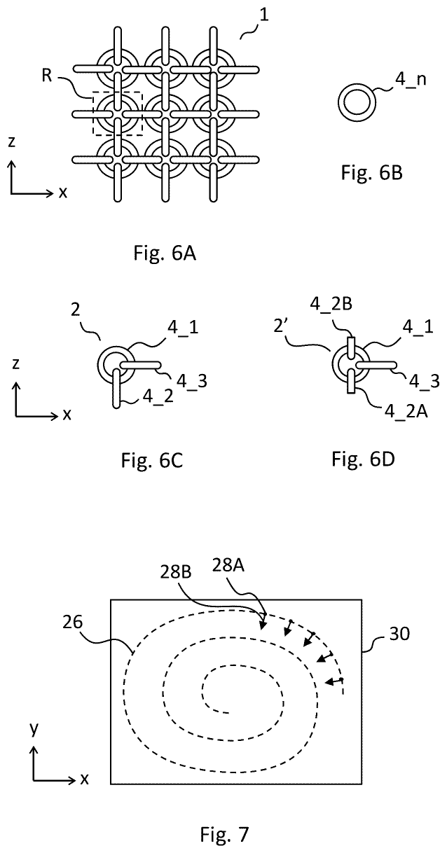

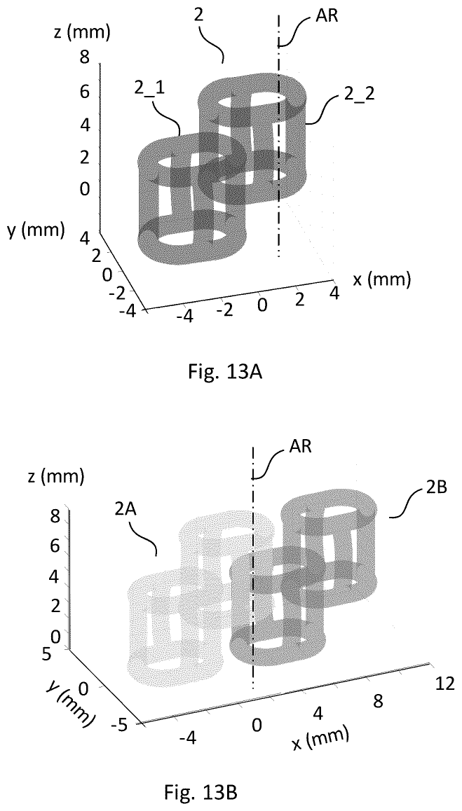

It will be appreciated that is not essential that the links of the chain are the same shape; it is here shown identical for ease of illustration. In other variants, the shapes may be different. Furthermore, it will be appreciated that the repeat unit may be defined differently to the one shown in FIG. 2C. Other shapes of repeat unit may require different variants of the repeat unit, and which optionally may comprise copying repeat unit slice stacks such that they overlap with an adjacent unit slice stack. Alternatively, or in addition, the repeat unit slice stack may not be in the form of a cuboid, but may take any suitable form to delineate the filled voxels within the repeat unit slices. Examples of this will be illustrated with reference to FIGS. 6C and 6D, and FIGS. 13A and 13B in relation to printed fabrics.

### Interlinking in and out of Plane

The above method according to the invention may be extended to generate bitmaps for a continuous surface formed from interlinking repeat units extending in more than one direction, wherein the majority of repeat units is interlinked with another repeat unit in more than two directions. FIG. 6A is a schematic illustration of a two-dimensional sheet of fabric 1 formed form a simple repeat unit that is interlinkable. The sheet extends in this example along the horizontal and vertical direction (x-z plane). FIG. 6B shows a subcomponent 4_n of the repeat unit 2 in FIG. 6C. The subcomponent is a simple ring-shaped subcomponent 4_n shown in plan view in FIG. 6B. Three of these identical subcomponents, namely 4_1, 4_2 and 4_3, form a repeat unit 2, shown along the x-z plane in FIG. 6C. The first subcomponent 4_1 is oriented such that it is viewed in plan view, whereas the second and third subcomponents 4_2 and 4_3 are viewed edge-on and loop through the first subcomponent 4_1.

Starting from the STL file of the repeat unit 2, the bitmap data for the repeat unit 2 is generated and forms the repeat unit slice stack 300. For efficient use of the build volume, the fabric sheet may be coiled (i.e. wound) around the vertical axis (z-axis) to stand upright within the virtual build volume 10. This means that for a simple coil, or bale, of fabric, each slice of the virtual build volume may comprise a spiral shaped cross section of the wound sheet and along which the positions and orientations for each repeating link may be defined. This is illustrated for an example slice 22 of the virtual build volume 10 in FIG. 7. Along the spiral path 26, a coordinate 28A and vector 28B is defined for each repeat unit slice stack 300. For the repeat unit shown in FIG. 6C, it is apparent that adjacent repeat unit slice stacks are copied into the base slice stack overlapping the neighbouring base slice stack so as to form the interlink. By defining the repeat unit as shown, and copying with overlap, reorientation is performed for the repeat unit and not over a subcomponent 4. For example, if the repeat unit were to be defined as outlined by R in FIG. 6A, subcomponent 4_3 cannot be oriented along a curved path as required in FIG. 7. Such re-orientation between adjacent repeat units requires to be performed by rotating full links 4_3, or repeat unit slice stacks 300 comprising bitmap representations of full links 4_n. For a vertically oriented bale, an alternative repeat unit 2′ may be defined as illustrated in FIG. 6D, for which the second subcomponent has been split into a partial lower and a partial upper subcomponent 4_2A and 4_2B, such that overlap with a neighbouring repeat unit slice stack 300 is required only along the direction of the path 60. After all repeat unit slice stacks 300 have been positioned and oriented in the base slice stack 30, the base slice stack may simply be repeated along the vertical direction to form an interlinked network of repeat units 2′ along the vertical direction. In the case of the initial repeat unit 2, successive base slice stacks 30 required overlap with the adjacent, lower base slice stack 30 to form the interlink. Thus the copy and pasting action of base slice stacks 30 further required an offset along z to include the interlinking portions within the preceding base slice stack 30. For a simple sheet of fabric wound into a vertical bale, the alternative repeat unit 2′ would appear to be more efficient since fewer instances of base slice stacks 30 need to be copied.

The repeat unit may therefore be defined and/or the repeat unit slice stacks 300 and/or the base slice stack 30 may be copied in such a way that interlinking is generated along the vertical direction between adjacent repeated base stack slices as well as in the lateral direction. The positions for each repeat unit slice stack 300 may be defined along a curved path 26, such as a spiral path, or an open or closed meandering or otherwise curved path, and the orientations and spacings between the origins of the repeat unit slice stacks may be defined based on the curvature-for example the orientation may be based on the tangent to the curve at any given position.

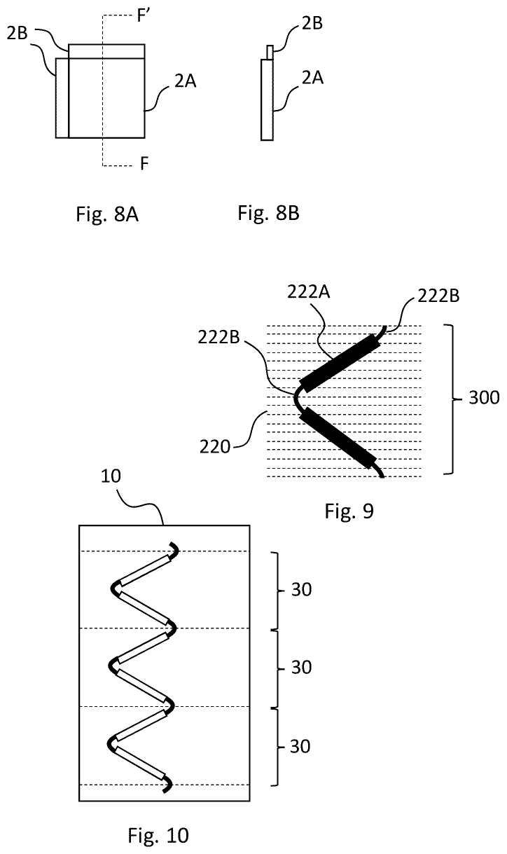

Herein, the reference to fabric is intended to mean any continuous structure comprising, or comprised of, a multitude of repeat units, such as an interlinked mesh of a double yarn type weave or single yarn type knit, or a multitude of repeat units linked to one another in any other suitable way. The repeat unit may not interlink by looping or weaving but may be structures such as plates or scales connected to one another by a coupling portion as exemplified in FIGS. 8A to 10. By multitude of repeat units it is intended to signify an prohibitively large number of units that would require excessive computational resource so as to make the process non-viable if the number of units were to be positioned in STL form within the virtual build volume before slicing.

### Folded Fabrics: FIGS. 8A-10

FIG. 8A illustrates a schematic plan view of a smallest repeat unit of a fabric made up of rectangular scales 2A having a first thickness and connected by thin flexible links 2B, as can be seen in in FIG. 8B, which is a side view of the repeat unit along a section F-F′ of FIG. 8A. The linking unit 2B may be of any suitable design specific to the function of the material to be formed-for example hinged, or elastic. The scale may be of any suitable shape. Using known principles of origami folding while considering the limitations of how close the link components may be fabricated to one another, a complex shape may be created that can be folded so as to be make the most efficient use of the build volume of an apparatus for the manufacture of the complex shape, and to create objects that once unfolded extend well beyond the dimensions of the available build volume. The complex shape may be a garment such as a dress, or a bag and so on. An algorithm used to define the folded shape may further be built upon to define the positions and orientations of each repeat unit. This results in repeat units angled in a multitude of orientations, i.e. that require rotation along the y and/or x axis as well as the z axis.

Based on the shape of the object model repeat unit, a different orientation with respect to the x and/or y axis as out of plane rotation may result in different numbers of repeat unit slice stacks that form a repeat unit slice stack. Thus, a plurality of repeat unit slice stacks may be predefined, each for a different orientation, such that at each position, the respective repeat unit slice stack may be selected based on the specific orientation.

FIG. 9 illustrates in a side view a simple fold using a repeat unit based on the design of FIGS. 8A and 8B. FIG. 12 is a representation of a repeat unit slice stack 300, comprising two repeat unit bitmaps 222 comprising a scale 222A and linking portion 222B each, in a side view. The two bitmaps are mirroring each other about the horizontal plane of the slices 220. This may define a repeating unit along the vertical direction, for example, although other repeating units may be envisaged, for example a single repeat unit 222 that is inverted over alternate repeat unit slice stacks.

Over the virtual build volume, the repeat unit slice stack 300 is comprised over a base slice stack 30 as shown in FIG. 10, which is a portion of a cross section through a virtual build volume 10 that has been sliced and fitted with one or more repeat unit slice stacks 300 over slices 30. These base slices are repeated to form a concertina shape of the repeat unit of FIG. 9. The unfolded length of repeat units extends over a length that exceeds the dimensions of the build volume, thus it can be seen how the principle of applying the method described herein using an algorithm to define the position and orientation of each repeat unit over the virtual build volume 10 can be used to form a complex shape comprising a multitude of repeat units, allowing the bitmap data to be generated in an efficient way without excessive computational resource. It will be appreciated that any approach of using the build volume effectively, resulting in folding and/or close packing of a multitude of repeat units leads to even larger demands on computational resource and requires solutions such as the method and its variants disclosed herein.

In variants of the method, the repeat unit slice stack 300, or the repeat unit slice stack and a different, further repeat unit slice stack, may be defined so as to form a folded interlinked object at block 540, and wherein the plurality of positions and orientations defined at step (c) are such that the interlinked object extends along a vertical dimension that is larger than the vertical dimension of the build volume in which it is to be formed. The use of different repeat unit slice stacks is further described with reference to FIG. 15.

In the case of interlinked structures within an object such as a fabric, the object model repeat unit may be defined such that in combination with suitably defined positions and orientations defined at block 530, adjacent repeat unit slice stacks 300 are to be positioned and oriented at block 540 so as to form interlinked pairs of object repeat units within the same base slice stack.

In variants of the method where the base slice stack is repeated vertically, the object model repeat unit may further be defined such that repeat unit slice stacks vertically adjacent between adjacent base slice stacks are positioned and oriented at block 540 so as to form vertically interlinked pairs of object repeat units. Optionally, the object model repeat unit 2 may be defined such that laterally adjacent repeat unit slice stacks 300 are to be positioned and oriented at block 540 to form an overlap between adjacent repeat unit slice stacks 300. This may be necessary depending on the axis of rotation around the interlinking portion that interlinks laterally adjacent object model repeat units. Similarly, where the base slice stack 30 is repeated along the vertical direction, adjacent base slice stacks 30 may partially overlap to as to correctly define the interlinking portion between vertically adjacent object model repeat units. An example object model repeat unit 2 that requires overlap is illustrated in a 3D perspective in FIG. 13A. The object model repeat unit 2 has two identical subcomponents 2_1 and 2_2 that interlink with one another. An axis of rotation AR of a further interlink with an adjacent object model repeat unit is also shown. FIG. 13B shows two object model repeat units 2A and 2B placed adjacent one another as they may be in repeat unit slice stack format according to the method described herein. It can be seen how the two repeat unit slice stacks overlap about the axis of rotation AR. This may further be the axis about which the second repeat unit slice stack is oriented with respect to the first one. It can be seen how some voxels of a corresponding second repeat unit slice stack require pasting within the outline of the voxels of the first repeat unit slice stack.

The object model repeat unit 2 of for example FIGS. 6D, 9 and 13A may define a repeat unit for forming a fabric. To ensure that the formed object model repeat units 2 retain sufficient spacings to adjacent object model repeat units to allow a formed fabric to flex and move and not fuse together, the positions and orientations defined at block 530 may be based on a defined threshold separation distance between adjacent repeat unit stacks. The threshold separation distance may in turn be based on the technology and apparatus specifics and the material properties used to form the interlinking repeat units, object, or fabric.

Returning to the illustration of FIG. 13B, the object model repeat unit 2 may comprises one or more subcomponents defining the object repeat unit, and the positions and orientations defined at block 530 may be based on a defined threshold separation distance between at least one of the one or more subcomponents of the adjacent object model repeat unit 2. This may be subcomponents in the form of those voxels closest to one another about the rotation axis AR. Further, with reference to FIG. 9, a defined threshold separation distance may prevent too sharp bends or folds in a fabric, or within adjacent complex interlinks.

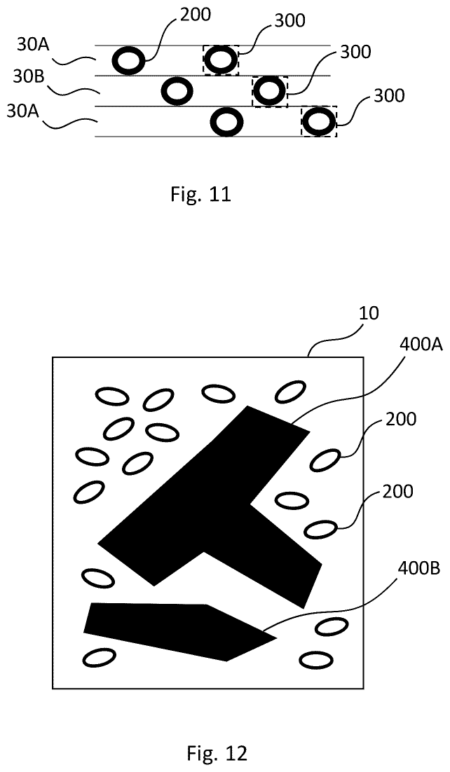

### Non-Interlinking Multitude of Identical Small Parts: FIGS. 11, 12

In applications where a plurality of non-interlinking small identical parts are to be formed within a relatively much larger build volume, the described method according to the invention may equally be applied. FIG. 11 illustrates a cross section through three sequential base slice stacks 30A and 30B into which repeat unit slice stacks 300 (in dashed outline) comprising a voxel outline 200 of a repeating object model with circular cross section have been placed. The repeat unit slice stacks 300 are arranged in a regular pattern at regular spacings within base slice stacks 30. In this example, the orientations are the same for all objects, while the positions differ between the two types of base slice stacks 30A and 30B. The positions are defined so as to create a staggered arrangement of repeat unit slice stacks 300 between adjacent base slice stacks 30A and 30B, in which an even offset distance between vertically adjacent repeat unit slice stacks 300 is provided. The two types of base slice stacks 30A, 30B may be repeated alternately, creating the same offset spacing between an array of repeat unit slice stacks 300 generated by multiple alternating base slice stacks 30A and 30B. This may provide a similar thermal environment for the repeated objects during manufacture.

The slices 22 of the virtual build volume 10 may not be empty before positioning and orienting repeat unit slice stacks comprising voxel outlines 200 within base slice stacks of the virtual build volume 10. One or more object models may be placed into the virtual build volume 10 before slicing the virtual build volume to provide the plurality of virtual build volume slices at block 520, such that the virtual build volume slices already comprise voxels for one or more objects before applying blocks 530 and 540. This is illustrated in FIG. 12, showing in a schematic cross section a virtual build volume 10 in which two large objects have been placed and the virtual build volume was then sliced. The slices of the virtual build volume comprise the voxel data 400A, 400B for the two objects. At block 530, a plurality of repeat unit slice stacks 300 may be copied in the empty portions around the voxels of the larger object according to the defined position and orientation at block 530. In other words, the repeat unit slice stacks of voxel data 200 for a plurality of smaller object repeat units may be copied and pasted into the virtual build volume slices to fit around existing data. This may utilise the remaining build volume efficiently. The coordinates for the repeat unit slice stacks may be provided to copy the voxel data at different orientations along the layering direction, or by coping in different base slice stacks representing the object model repeat unit at different orientations. This may be useful when small objects like rings or other jewellery, or small mechanical parts are to be formed. The different orientations may improve a uniform distance from a surface of the one or more larger objects. The base slice stack 30 in this example may extend over the majority of the virtual build volume 10 and the repeat unit slice stacks 300 comprise significantly fewer layers than the base slice stack and such that the positions are defined throughout the entire virtual build volume. Variants of this approach may be envisaged. For example, based on the voxel positions defining the larger object(s) comprised within the sliced virtual build volume, sub-volumes of the virtual build volume slices may be defined and within which a plurality of the repeat unit slice stacks are placed. For example, the repeat unit slice stack may comprise two or more object model repeat units. Optionally, the second object model repeat units 2 may be at a different orientation, with respect to the layering direction, to the first object model repeat unit 2. Thus clusters of repeat units may be defined within the repeat unit slice stack. This may further reduce the time to copy and paste the repeat unit slice stacks into the empty portions of the virtual build volume slices.

### Different Repeat Unit Slice Stacks

The use of different repeat unit slice stacks is further illustrated with reference to the block diagram of FIG. 15, which is a further variant of the method 500 of FIG. 1 and in which two different object model repeat unit are defined and sliced at respective blocks 510A and 510B. This variant may equally apply to generating bitmap data for interlinked object model repeat units or for object model repeat units positioned throughout the virtual build volume and/or around the voxels of a larger object model as described with reference to FIGS. 11 and 12. The further object model repeat unit 2 may be of a further design such as a different shape or orientation compared to the first object model repeat unit. For example, an interlinked object may be comprised of two different designs and/or sizes of object model repeat units, or may require a base slice stack of the same object model repeat unit 2 but at a different orientation with respect to the layering direction. At block 530, the positions and orientations of the first and second (initial and further) repeat unit slice stacks are defined within slices of the virtual build volume, in other words each position further defines its respective repeat unit slice stack. Based on whether a first or second repeat unit slice stack is required, the processor at block 550 selects the respective initial or further repeat unit slice stack and places it at block 540A at its defined position within the base slice stack and at its defined orientation, for example by rotating it about the vertical axis through its defined origin O. In this way, two different repeat unit slice stacks are placed and oriented within the same base slice stack of the virtual build volume. The two different repeat unit stacks 300 may comprise the same number of layers, or they may comprise a different number of layers to one another. One or both of them may comprise the same number of layers as, or fewer layers than, the base slice stack 30.

Alternatively, or in addition, the processor at block 550 may be instructed to place the first repeat unit slice stack in a first set of slices of the virtual build volume to form a first base slice stack at block 540A, and to place the second, further repeat unit slice stack in a second, further set of slices of the virtual build volume to form a second or further base slice stack at block 540B.

Alternatively, or in addition, and according to the example of FIG. 11, the processor at block 550 may be instructed to place the repeat unit slice stack in a first set of slices of the virtual build volume to form a first base slice stack 30A at block 540A, and to place the repeat unit slice stack in a second, further set of slices of the virtual build volume but at different positions compared to the first base slice stack, to form a second or further base slice stack 30B at block 540B.

At block 560, optionally, block 540A, or blocks 540A and 540B, may be repeated in any suitable order to fill the virtual build volume with a number of first and second base slice stacks. In further variants, a combination of both blocks may be applied, such that at least one of the set of base slice stacks comprises a mixture of the two different repeat unit slice stacks.

The repeat unit slice stacks and/or the further repeat unit slice stacks may interlink with another adjacent repeat unit slice stack and/or the further repeat unit slice stack in the vertical and/or horizontal direction, or they may be isolated repeated objects within the virtual build volume.

Blocks 510 to 530 may be repeated to generate repeat unit slice stacks 300 for different object repeat units 2, and/or for the same object repeat unit oriented differently with respect to the layering direction, and may further comprise storing the different repeat unit slice stacks so as to generate a library of different repeat unit slice stacks for respective orientations and/or types of object model repeat unit within the repeat unit slice stack 300. The different respective orientations may in this case only differ in rotation about the vertical axis, perpendicular to the layering direction, since further rotations may be defined within the repeat unit slice stack itself. Re-orienting the same or providing a different object repeat unit may result in different number of layers between different repeat unit slice stack. The number of layers of the repeat unit slice stack may in some cases therefore not be the same as that of a base slice stack, however the separation between the slice planes may be kept constant as may be based on the apparatus and accuracy requirements of the formed object. Where different repeat unit slice stacks are to be applied within the base slice stack, at block 530, the defined position may further comprise identification data for which repeat unit slice stack is to be used, such that block 540 further comprises selecting from a library of repeat unit slice stacks the required repeat unit slice stack based on the identification data. In variants of the method the repeat unit slice stack may be selected from a library of repeat unit slice stacks depending on the required orientation defined at block 530 and placed at the required position. Furthermore, based on the object repeat unit, the method may further comprise defining an overlap between two laterally adjacent repeat unit slice stacks and/or between adjacent base slice stacks such that adjacent repeat unit slice stacks are to form laterally and/or vertically interlinking object repeat units.

For simplicity, FIGS. 14 and 15 do not indicate the processor 600 configured to carry out the method but it will be appreciated that this equally applies to FIGS. 14 and 15.

As described herein, the method 500 and its variants described herein are particularly beneficial in applications in which the object model repeat unit is in STL format or similar, requiring a relatively larger file format than the repeat unit slice stack in raster format. The generated base slice stacks may be completed or combined and/or provided to an apparatus for manufacturing the plurality of object repeat units layer by layer based on the virtual build volume slices so as to form one or more objects from the object repeat units according to raster data generated according to the method and any of its variants described herein. The method and any of its variants may be carried out by processor 600 configured to generate formation data in the form of raster slices for an apparatus for the layerwise formation of objects.

The repeat unit stacks 300 may comprise the same number of layers as the base slice stack 30. Alternatively, the repeat unit stacks may comprise fewer layers. In any case the purpose of placing and orientating the repeat unit slice stacks at blocks 540 is to copy and paste the object model voxels into the virtual build volume slices in bitmap format. The position and orientation of the repeat unit slice stack may be defined in any suitable way to correctly place the voxel data into the virtual build volume slices. The base stack of slices of the virtual build volume may be a sub-volume of the virtual build volume. The base stack of slices may be copied and pasted along the vertical direction so as to form the completed slices of the virtual build volume ready to be provided to an apparatus for formation of the one or more objects. In this way, a bitmap for an object such as a bale of fabric composed of tens of thousands of links and wound about the vertical direction may be generated substantially by copying and pasting of bitmaps instead of generating it substantially from STL format.

1. A method for generating object formation data for a plurality of object model repeat units for the layerwise formation of object repeat units based on the formation data, the method comprising:
(a) providing a plurality of virtual build volume slices stacked in the layering direction of a corresponding object formation process and based on a thickness of layers of the object repeat units to be formed;
(b) slicing the object model repeat unit to form a repeat unit slice stack of repeat unit slices, the repeat unit slices being of same thickness in the layering direction as the virtual build volume slices;
(c) defining a position and orientation for each of a plurality of the repeat unit slice stacks over a number of base slices of the virtual build volume;
(d) generating a base slice stack by placing each of the plurality of the repeat unit slice stacks according to the defined position and orientation within the base slice stack; and
(e) repeating the base slice stack one or more times along the layering direction within the virtual build volume slices.

2. (canceled)

3. The method of claim 1, wherein the step (c) comprises defining a position for each repeat unit slice stack along a curved path and wherein the orientation of the plurality of the repeat unit slice stacks is defined by a rotation about the vertical axis though the position coordinate of each repeat unit slice stack.

4. The method of claim 1, wherein the object model repeat unit is to interlink with an adjacent object model repeat unit, wherein the method comprises defining the object model repeat unit before step (a) and the plurality of locations and orientations for the repeat unit slice stack at step (c) such that at step (d), the adjacent repeat unit slice stack defines interlinked adjacent object model repeat units.

5. The method of claim 4, wherein the repeat unit slice stack is defined so as to form a folded interlinked object, and wherein the plurality of positions and orientations defined at step (c) are such that the interlinked object, when unfolded, extends along a vertical dimension that is larger than the vertical dimension of the build volume in which it is to be formed.

6. The method according to claim 1, wherein the object model repeat unit is oriented at a defined orientation with respect to the layering direction, the method further comprising:
(f) repeating steps (a) to (c) for a different orientation of the object model repeat unit with respect to the layering direction to generate a different repeat unit slice stack, and wherein step (d) comprises, or further comprises:
(f1) generating the base slice stack within the virtual build volume by placing each of the plurality of the repeat unit slice stacks and one or more different repeat unit slice stacks according to their respective defined positions and orientations within the base slice stack; and/or
(f2) generating a further base slice stack by placing each of the plurality of the different repeat unit slice stacks according to their defined position and orientation within the further base slice stack.

7. The method of claim 6, further comprising generating a library of further repeat unit slice stacks for respective orientations of the object model repeat unit with respect to the layering direction, wherein the different respective orientations differ in rotation about an axis perpendicular to the layering direction.

8. The method of claim 7 comprising step (f1), wherein step (c) comprises defining identification data for the repeat unit slice stack and the further repeat unit slice stacks, and wherein step (f1) comprises selecting a required repeat unit slice stack based on the defined identification data.

9. The method of claim 1, wherein step (c) further comprises defining an overlap between two repeat unit slice stacks in adjacent base slice stacks such that the two repeat unit slice stacks are to form interlinking object repeat units.

10. (canceled)

11. The method of claim 1, wherein the repeat unit slice stack comprises two or more object model repeat units at a different orientation to one another.

12. (canceled)

13. The method of any claim 1, wherein the plurality of positions and orientations defined at step (c) are based on; a defined object separation distance between the object model repeat unit and an adjacent object model repeat unit, and/or a defined threshold separation distance between adjacent repeat unit stacks.

14. The method of claim 1, wherein the object model repeat unit is defined such that adjacent repeat unit slice stacks of the plurality of repeat unit slice stacks are to be positioned and oriented in step (d) so as to define an interlinked pair of object model repeat units within the same base slice stack and/or between adjacent base slice stacks.

15. (canceled)

16. The method of claim 14, wherein the object model repeat unit is defined such that adjacent repeat unit slice stacks of the plurality of repeat unit slice stacks are to be positioned and oriented in step (d) to form an overlap between adjacent repeat unit slice stacks.

17. (canceled)

18. The method of claim 13, wherein the repeat unit stack comprises one or more subcomponents defining the object repeat unit, and wherein the plurality of positions and orientations defined at step (c) are based on a defined threshold separation distance between at least one of the one or more subcomponents of the adjacent repeat unit stacks.

19. The method of claim 1, wherein the virtual build volume further comprises one or more object models before applying step (b) of slicing the virtual build volume, such that the virtual build volume slices comprise data for one or more objects before placing each of the plurality of the repeat unit slice stacks according to the defined position and orientation within the one or more base slices.

20. The method according to claim 1, wherein the number of slices of the repeat unit slice stack is the same as the number of slices of the base layer stack.

21. The method according to claim 1, wherein the object model repeat unit is in STL format and the repeat unit slice stack is in raster format.

22. The method according to claim 1, comprising manufacturing the plurality of repeating elements layer by layer based on the virtual build volume slices.

23. An object comprised of object model repeat units manufactured from object formation data generated according to the method of claim 1.

24. The object of claim 23, wherein each object model repeat unit interlinks with at least one other object model repeat unit.

25. A processor configured to generate object formation data for an apparatus for the layerwise formation of objects according to the method of claim 1.
